(19) United States
(12) Patent Application Publication
(10) Pub. No.: US 2026/0296102 A1
(43) Pub. Date: Oct. 1, 2026

(54) HIGH LOAD CAPACITY TIRE HAVING TEAR-RESISTANT SIDEWALLS

(71) Applicant: COMPAGNIE GENERALE DES ETABLISSEMENTS MICHELIN, Clermont-Ferrand (FR)

(72) Inventors: OLIVIER MUHLHOFF, Clermont-Ferrand (FR); SYLVAIN MAYER, Clermont-Ferrand (FR); ALINE RIOU, Clermont-Ferrand (FR); YOSHIKO MAETA, Clermont-Ferrand (FR)

(21) Appl. No.: 19/480,627

(22) PCT Filed: Apr. 30, 2024
(86) PCT No.: PCT/EP2024/061836

§ 371 Date: Oct. 31, 2025

(30) Foreign Application Priority Data
May 3, 2023 (FR) 2304435

(51) Int. Cl. B60C 1/00; B60C 13/00; C08K 3/04; C08L 9/00

(52) U.S. Cl. CPC B60C 1/0025; B60C 13/00; C08K 3/04; C08L 9/00; B60C 2013/005

(57) ABSTRACT

The tire (10) for a passenger vehicle comprises a crown (12), two beads (32), and two sidewalls (30) connecting each bead (32) to the crown (12). The tire (10) is of HIGH LOAD CAPACITY type as defined in the 2021 ETRTO Standards Manual. At least one of the two sidewalls (30) comprises an elastomer composition based on at least one elastomer matrix, at least one reinforcing filler, and at least one rubber crumb. The sum of the content of reinforcing filler and the content of rubber crumb is greater than or equal to 30 phr. The weight ratio between the content of rubber crumb expressed in phr and the content of reinforcing filler expressed in phr is within a range from 0.20 to 1.50.

The present invention relates to a tyre. The term “tyre” should be understood to mean a tyre casing intended to form a cavity by interacting with a support element, for example a rim, this cavity being capable of being pressurized to a pressure greater than atmospheric pressure. A tyre according to the invention has a structure of substantially toroidal shape exhibiting symmetry of revolution about a main axis of the tyre.

The advent of electric or hybrid passenger vehicles is leading to an increase in the weight of the vehicles, notably on account of the batteries, the weight of which is relatively great and substantially proportional to the range (autonomy) of the vehicles. Thus, for example, in order to increase the range of an electric vehicle, it is necessary to increase the size of its batteries and, as a result, the weight of the vehicle.

Simply put, it is currently estimated that each kilometre of range of an electric motor increases the weight of the vehicle by one kilogram. Thus, in order to achieve a range of 500 kilometres, it is necessary to increase the weight of a vehicle with combustion engine propulsion by approximately 500 kg. Such vehicles need to be fitted with tyres capable of bearing a very high load.

Thus, tyre manufacturers have decided to create a new type of tyre. This new type is now known by the denomination “HIGH LOAD CAPACITY” (or High Load) in the 2021 ETRTO Standards Manual. This new type of tyre makes it possible to guarantee that the load that the tyre of a given size is capable of bearing is higher than that which a tyre of the same size, but in its EXTRA LOAD version, would be capable of bearing. For the 255/35R18 size, the tyre of the HIGH LOAD CAPACITY type thus has a load index equal to 98, indicating that it is capable of bearing a load of 750 kg at a pressure of 290 kPa. By way of comparison, for the same size, 255/35R18, the tyre of the EXTRA LOAD type has a load index equal to 94, indicating that, at a pressure of 290 kPa, this tyre is capable of bearing a load of 670 kg.

One problem encountered is linked to the fact that, for a given size, a HIGH LOAD CAPACITY tyre is required to bear a relatively high load causing significant flexion of the sidewalls and making them sensitive to tearing, particularly when driving over a deep hole in the road or over a large bump in the road, when suddenly mounting the pavement, when used at a pressure significantly lower than the recommended pressure or when used under a load significantly greater than the maximum load.

It is an aim of the invention to provide a tyre capable of bearing a greater load than existing tyres while at the same time increasing its tear strength.

To this end, the invention relates to a tyre for a passenger vehicle comprising a crown, two beads, two sidewalls connecting each bead to the crown, the tyre being of HIGH LOAD CAPACITY type as defined in the 2021 ETRTO Standards Manual, at least one of the two sidewalls comprises an elastomer composition based on at least one elastomer matrix, at least one reinforcing filler, at least one rubber crumb, the sum of the content of reinforcing filler and the content of rubber crumb is within a range from 46 to 62 phr and the weight ratio between the content of rubber crumb expressed in phr and the content of reinforcing filler expressed in phr being within a range from 0.20 to 1.50.

The inventors have surprisingly discovered that one way of solving this problem is to use a specific elastomer composition based on at least one elastomer matrix, at least one reinforcing filler, at least one rubber crumb having certain weight characteristics between the content of reinforcing filler and the content of rubber crumb. This elastomer composition has excellent tear strength.

According to the invention, the tyre is for passenger vehicles. Such a tyre is for example defined in the 2021 ETRTO (European Tyre and Rim Technical Organisation) Standards Manual. Such a tyre generally has, on at least one of the sidewalls, a marking conforming to the marking in the 2021 ETRTO Standards Manual indicating the size of the tyre in the form X/Y a V U B where X denotes the nominal section width, Y denotes the nominal aspect ratio, a denotes the structure and may be R or ZR, V denotes the nominal rim diameter, U denotes the load index and β denotes the speed symbol.

By increasing the load index of the tyre in comparison with the load index of a tyre of the same size in its EXTRA LOAD version, the invention makes it possible to increase the load-bearing capacity of the tyre without thereby modifying the habitability, the compactness and the comfort of the vehicle on which it is used. Specifically, because the size of the tyre of the invention is identical to that of the tyre in its EXTRA LOAD version, the tyre takes up no more space than the tyre in its EXTRA LOAD version. A tyre of the invention may bear distinctive markings so that it can be differentiated from its STANDARD LOAD version and from its EXTRA LOAD version, for example a marking of the HL (HIGH LOAD) or XL+ (EXTRA LOAD+) type. Such markings are notably disclosed in the 2021 ETRTO Standards Manual, on page 3 of the section entitled “General Notes-Passenger Car Tyres” for designating tyres of the HIGH LOAD CAPACITY type. Examples of sizes are also disclosed in the 2021 ETRTO Standards Manual, on page 44, paragraph 9.1 in the section entitled “Passenger Car Tyres-Tyres with Metric Designation”.

A tyre of the HIGH LOAD CAPACITY type may be characterized by its load index LI such that LI≥LI′+1, where LI′ is the load index of an EXTRA LOAD tyre of the same size in accordance with the 2021 ETRTO Standards Manual. The load index LI′ is the load index of an EXTRA LOAD tyre of the same size, namely of the same nominal section width, the same nominal aspect ratio, the same structure (R and ZR being considered to be identical) and same nominal rim diameter. The load index LI′ is given in the 2021 ETRTO Standards Manual, notably in the part entitled “Passenger Car Tyres-Tyres with Metric Designation”, pages 22 to 43. LI=LI′+1, or LI=LI′+2, or LI=LI′+3 or else LI=LI′+4, depending on the size. In most embodiments, LI′+1≤LI≤LI′+4, and even LI′+2≤LI≤LI′+4.

The tyre according to the invention has a substantially toroidal shape about an axis of revolution substantially coincident with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, that is to say the axis of rotation of the tyre.

The expression “circumferential direction” means the direction that is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The expression “median plane of the tyre” (denoted M) means the plane perpendicular to the axis of rotation of the tyre which is situated axially mid-way between the two beads and passes through the axial middle of the crown reinforcement.

The expression “equatorial circumferential surface of the tyre” means the combination of the planes passing, in each meridian section plane, through the equator (denoted E) of the tyre and perpendicular to the median plane and to the radial direction. The equator of the tyre is, in a meridian section plane (plane perpendicular to the circumferential direction and parallel to the radial and axial directions), the axis parallel to the axis of rotation of the tyre and situated equidistantly between the radially outermost point of the tread that is intended to be in contact with the ground, and the radially innermost point of the tyre that is intended to be in contact with a support, for example a rim, the distance between these two points being equal to H.

The expression “meridian plane” means a plane parallel to and containing the axis of rotation of the tyre and perpendicular to the circumferential direction.

The expressions “radially inner/inside” and “radially outer/outside” mean closer to the axis of rotation of the tyre and further away from the axis of rotation of the tyre, respectively. The expressions “axially inner/inside” and “axially outer/outside” mean closer to the median plane of the tyre and further away from the median plane of the tyre, respectively.

The term “bead” means the portion of the tyre intended to allow the attachment of the tyre to a mounting support, for example a wheel comprising a rim. Thus, each bead is in particular intended to be in contact with a flange of the rim allowing it to be attached. Thus, the radially outer end of the exterior surface of the bead of the tyre is defined as the radially outermost point on the exterior surface of the tyre in contact with a measuring rim of the tyre according to the 2021 ETRTO Standards Manual, when the tyre is inflated to its nominal pressure on this measuring rim.

Any range of values denoted by the expression “between a and b” indicates the range of values extending from more than a to less than b (i.e., endpoints a and b excluded), whereas any range of values denoted by the expression “from a to b” means the range of values extending from a up to b (i.e., including the strict endpoints a and b).

The expression “composition based on” should be understood as meaning a composition including the mixture and/or the product of the in situ reaction of the various constituents used, some of these constituents being able to react and/or being intended to react with each other, at least partially, during the various phases of manufacture of the composition; the composition thus possibly being in the totally or partially crosslinked state or in the non-crosslinked state.

For the purposes of the present invention, the expression “part by weight per hundred parts by weight of elastomer” (or phr) should be understood to mean the part by weight per hundred parts by weight of elastomer in the sense of the preparation of the composition before curing. In other words, in the case of the presence of a rubber crumb, the term “phr” means part by weight per hundred parts of “new” elastomers, thus excluding from the base 100 the elastomers contained in the rubber crumb.

In the present text, unless expressly indicated otherwise, all the percentages (%) indicated are mass percentages (%).

When reference is made to a “predominant” compound, this means, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. Similarly, a “predominant” filler is the one representing the greatest mass among the fillers in the composition. By way of example, in a system comprising only one elastomer, the latter is predominant for the purposes of the present invention; and in a system comprising two elastomers, the predominant elastomer represents more than half of the mass of the elastomers. In contrast, a “minor” compound is a compound which does not represent the greatest mass fraction among the compounds of the same type. Preferably, the term “predominant” means present to more than 50%, preferably more than 51%, 60%, 70%, 80%, 90%, and more preferentially the “predominant” compound represents 100%.

The compounds mentioned in the description may be of fossil origin or may be biobased. In the latter case, they may be partially or completely derived from biomass or obtained from renewable raw materials derived from biomass. Obviously, the compounds mentioned may also be derived from the recycling of already-used materials, i.e. they may be partly or totally derived from a recycling process, or obtained from raw materials which are themselves derived from a recycling process. They notably include polymers, plasticizers, fillers, etc.

The elastomer composition comprises at least one elastomer, for example a diene elastomer. In some optional embodiments, the elastomer composition comprises several elastomers, in particular several diene elastomers. In the remainder of the description, this elastomer or this mixture of elastomers, particularly diene elastomers, is referred to as the elastomer matrix. In the case where the composition comprises several elastomers, these elastomers are of course all different from one another.

The term “elastomer” means a polymer, i.e. a homopolymer or a copolymer, having elastic properties obtained after crosslinking. The term rubber is a common synonym for elastomer.

“Diene elastomer” (or, without distinction, “diene rubber”), whether natural or synthetic, is given to mean, as is known, an elastomer at least partially composed (i.e. a homopolymer or a copolymer) of diene monomer units (monomers bearing two conjugated or non-conjugated carbon-carbon double bonds). Diene elastomers are by definition non-thermoplastic.

Preferably, the elastomer matrix comprises at least two diene elastomers that are different to one another.

These diene elastomers can be classified into two categories: “essentially unsaturated” or “essentially saturated”. “Essentially unsaturated” is generally intended to mean a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may notably be termed “essentially saturated” diene elastomers (low or very low content, always less than 15%, of units of diene origin).

A diene elastomer capable of being used in the elastomer compositions is understood in particular as meaning:
any homopolymer of a conjugated or non-conjugated diene monomer having from 4 to 18 carbon atoms;
any copolymer of a conjugated or non-conjugated diene having from 4 to 18 carbon atoms and of at least one other monomer; the other possibly being ethylene, an olefin or a diene, conjugated or non-conjugated.

Conjugated dienes that are suitable include conjugated dienes containing from 4 to 12 carbon atoms, in particular 1,3-dienes, notably such as 1,3-butadiene and isoprene.

Non-conjugated dienes that are suitable include non-conjugated dienes containing from 6 to 12 carbon atoms, such as 1,4-hexadiene, ethylidenenorbornene or dicyclopentadiene.

Olefins that are suitable include vinylaromatic compounds containing from 8 to 20 carbon atoms and aliphatic α-monoolefins containing from 3 to 12 carbon atoms.

Vinylaromatic compounds that are suitable include, for example, styrene, ortho-, meta- or para-methylstyrene, the “vinyltoluene” commercial mixture or para-(tert-butyl) styrene.

Aliphatic α-monoolefins that are suitable notably include acyclic aliphatic α-monoolefins containing from 3 to 18 carbon atoms.

More particularly, the diene elastomer is:
any homopolymer of a conjugated diene monomer, in particular any homopolymer obtained by polymerization of a conjugated diene monomer having from 4 to 12 carbon atoms;
any copolymer obtained by copolymerization of one or more conjugated dienes with one another or with one or more vinylaromatic compounds having from 8 to 20 carbon atoms;
any copolymer obtained by copolymerization of one or more conjugated or non-conjugated dienes with ethylene, an α-monoolefin or a mixture thereof, such as, for example, the elastomers obtained from ethylene, from propylene with a non-conjugated diene monomer of the abovementioned type.

According to an advantageous embodiment making it possible to improve the tear strength, the elastomer matrix comprises at least one isoprene elastomer and at least one butadiene elastomer.

The term “isoprene elastomer” means, in a known manner, an isoprene homopolymer or copolymer, in other words an isoprene elastomer may be selected from the group consisting of natural rubber (NR), synthetic polyisoprenes (IRs), the various isoprene copolymers, and mixtures of these elastomers. Isoprene copolymers include in particular isobutene/isoprene (butyl rubber-IIR), isoprene/styrene (SIR), isoprene/butadiene (BIR) or isoprene/butadiene/styrene (SBIR) copolymers. Preferably, the isoprene elastomer may be selected from the group consisting of natural rubber, synthetic cis-1,4-polyisoprenes, and mixtures of these elastomers. More preferentially still, the isoprene elastomer is selected from the group consisting of natural rubber, synthetic polyisoprenes having a content (mol %) of cis-1,4 bonds of greater than 90% (more preferentially still of greater than 98%), and mixtures of these elastomers. In a preferred embodiment, the content of isoprene elastomer is within a range from 20 to 80 phr, preferably from 30 to 70 phr, more preferentially between 30 and 70 phr and even more preferentially from 35 to 65 phr.

The term “butadiene elastomer” means, in a known manner, a butadiene homopolymer or copolymer, in particular a diene elastomer that may be selected from the group consisting of polybutadienes (BR), the various butadiene copolymers, and mixtures of these elastomers. Among the butadiene copolymers, mention will be made in particular of butadiene/styrene (SBR) or ethylene/butadiene (EBR) copolymers. Preferentially, the butadiene elastomer may be a cis-1,4-polybutadiene; notably a polybutadiene having a content (mol %) of cis-1,4 bonds of greater than 90%, more preferentially still of greater than 96%. In a preferred embodiment, the content of butadiene elastomer is within a range from 20 to 80 phr, preferably from 30 to 70 phr, more preferentially between 30 and 70 phr and even more preferentially from 35 to 65 phr.

Preferably in this advantageous embodiment, the elastomer matrix comprises at least one isoprene elastomer selected from the group consisting of natural rubber (NR), synthetic cis-1,4-polyisoprenes (IR), in particular those having a content (mol %) of cis-1,4 bonds of greater than 90% (more preferably still greater than 98%), isoprene/styrene copolymers (SIR), isoprene/butadiene copolymers (BIR), isoprene/butadiene/styrene copolymers (SBIR), and mixtures of these elastomers and at least one butadiene elastomer selected from the group consisting of polybutadienes (BR), in particular a cis-1,4-polybutadiene having a content (mol %) of cis-1,4 bonds of greater than 90% (more preferably still greater than 96%), butadiene/styrene copolymers (SBR), ethylene/butadiene copolymers (EBR), and mixtures of these elastomers.

More preferably still, the elastomer matrix comprises at least one isoprene elastomer selected from the group consisting of natural rubber (NR), synthetic cis-1,4-polyisoprenes (IR), in particular those having a content (mol %) of cis-1,4 bonds of greater than 90% (more preferably still greater than 98%), and mixtures of these elastomers and at least one butadiene elastomer which is a polybutadiene (BR), in particular a cis-1,4-polybutadiene having a content (mol %) of cis-1,4 bonds of greater than 90% (more preferably still greater than 96%).

More preferably still, the elastomer matrix comprises at least one isoprene elastomer which is natural rubber (NR) and at least one butadiene elastomer which is a polybutadiene (BR), in particular a cis-1,4-polybutadiene having a content (mol %) of cis-1,4 bonds of greater than 90% (more preferably still greater than 96%).

In preferred embodiments in which the elastomer matrix comprises at least one isoprene elastomer and at least one butadiene elastomer, the content of isoprene elastomer is within a range from 20 to 80 phr, and the content of butadiene elastomer is within a range from 20 to 80 phr. Preferably, in this embodiment, the content of isoprene elastomer is within a range from 30 to 70 phr, and the content of butadiene elastomer is within a range from 30 to 70 phr. More preferentially, the content of isoprene elastomer is within a range between 30 and 70 phr, and the content of butadiene elastomer is within a range between 30 and 70 phr. More preferentially still, the content of isoprene elastomer is within a range from 35 to 65 phr, and the content of butadiene elastomer is within a range from 35 to 65 phr. These contents make it possible to obtain a sidewall with good tear strength.

In a particularly advantageous embodiment, the elastomer matrix comprises at least one isoprene elastomer and at least one butadiene elastomer; the isoprene elastomer being selected from the group consisting of natural rubber (NR), synthetic cis-1,4-polyisoprenes (IR), in particular those having a content (mol %) of cis-1,4 bonds of greater than 90% (more preferably still greater than 98%) and the content of this isoprene elastomer being within a range from 20 to 80 phr, preferably from 30 to 70 phr, preferentially between 30 and 70 phr, more preferentially still from 35 to 65 phr; the butadiene elastomer being a polybutadiene (BR), in particular a cis-1,4-polybutadiene having a content (mol %) of cis-1,4 bonds of greater than 90% (more preferably still greater than 96%) and the content of this butadiene elastomer being within a range from 20 to 80 phr, preferably from 30 to 70 phr, preferentially between 30 and 70 phr, more preferentially still from 35 to 65 phr.

### Reinforcing Filler

The elastomer composition of the sidewall of the invention comprises at least one reinforcing filler (i.e. one or more reinforcing fillers).

Use may be made of any type of “reinforcing” filler known for its abilities to reinforce an elastomer composition which can be used in particular for the manufacture of tyres, for example an organic filler, such as carbon black, an inorganic filler, such as silica or alumina, or a mixture of these types of fillers. For the purposes of the present invention, the rubber crumb described below is not considered to be a reinforcing filler within the meaning of the invention. Consequently, the content of rubber crumb is not included in the content of reinforcing filler and is a content distinct from the latter.

Preferably, the content of reinforcing filler is within a range from 5 to 70 phr, preferably from 5 to 60 phr, more preferentially from 5 to 55 phr, even more preferentially between 5 and 55 phr, very preferentially between 10 and 50 phr and most preferentially from 20 to 45 phr. These contents make it possible to obtain a sidewall with good tear strength properties.

Suitable carbon blacks include all carbon blacks, notably the blacks conventionally used in tyres. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks may be used in isolated form, as commercially available, or in any other form, for example as support for some of the rubber engineering additives used. The carbon blacks might for example already be incorporated in the diene elastomer, in particular isoprene elastomer, in the form of a masterbatch (see for example applications WO97/36724-A2 or WO99/16600-A1).

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, which is capable of reinforcing, by itself alone, without means other than an intermediate coupling agent, an elastomer composition intended for the manufacture of tyres. In a known way, some reinforcing inorganic fillers can be characterized in particular by the presence of hydroxyl (—OH) groups at their surface.

Mineral fillers of the siliceous type, preferentially silica (SiO₂), or of the aluminous type, in particular alumina (Al₂O₃), are notably suitable as reinforcing inorganic fillers. The silica used may be any reinforcing silica known to those skilled in the art, in particular any precipitated or fumed silica having a BET specific surface area and also a CTAB specific surface area both of less than 450 m²/g, preferably within a range from 30 to 400 m²/g, in particular from 60 to 300 m²/g. The BET specific surface area is determined by gas adsorption using the Brunauer-Emmett-Teller method described in “The Journal of the American Chemical Society” (vol. 60, page 309, February 1938), and more specifically according to a method derived from the standard NF ISO 5794-1, Annex E, of June 2010 [multipoint (5 point) volumetric method-gas: nitrogen—degassing under vacuum: one hour at 160° C.—relative pressure p/p₀ range: 0.05 to 0.17]. The CTAB specific surface values of the silica were determined according to the Standard NF ISO 5794-1, Appendix G, of June 2010. The process is based on the adsorption of CTAB (N-hexadecyl-N,N,N-trimethylammonium bromide) on the “outer” surface of the reinforcing filler.

Use may be made of any type of precipitated silica, in particular highly dispersible precipitated silicas (HDS). These precipitated silicas, which are or are not highly dispersible, are well known to a person skilled in the art. Mention may be made, for example, of the silicas described in applications WO03/016215-A1 and WO03/016387-A1. Among the commercial HDS silicas, use may in particular be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay.

The physical state in which the reinforcing inorganic filler is provided is not important, whether it be in the form of a powder, micropearls, granules, beads or any other appropriate densified form. Needless to say, the term “reinforcing inorganic filler” also refers to mixtures of different reinforcing inorganic fillers, in particular of silicas as described above.

In order to couple the reinforcing inorganic filler, in particular silica, to the diene elastomer, use may be made, in a well-known manner, of an at least difunctional coupling agent (or bonding agent) intended to provide a satisfactory connection, of chemical and/or physical nature, between the inorganic filler (surface of its particles) and the diene elastomer. In particular, use is made of at least difunctional organosilanes or polyorganosiloxanes having a first functional group that is capable of interacting with the inorganic filler and a second functional group that is capable of interacting with the diene elastomer. For example, such a difunctional compound may comprise a first functional group comprising a silicon atom, said first functional group being capable of interacting with the hydroxyl groups of an inorganic filler, and a second functional group comprising a sulphur atom, said second functional group being capable of interacting with the diene elastomer. Preferentially, the organosilanes are selected from the group consisting of organosilane polysulphides (symmetrical or asymmetrical), such as bis(3-triethoxysilylpropyl)tetrasulphide, abbreviated to TESPT, sold under the name Si69 by Evonik, or bis(3-triethoxysilylpropyl)disulphide, abbreviated to TESPD, sold under the name Si75 by Evonik, polyorganosiloxanes, mercaptosilanes, blocked mercaptosilanes, such as S-(3-(triethoxysilyl)propyl) octanethioate, sold by Momentive under the name NXT Silane. More preferentially, the organosilane is an organosilane polysulphide.

According to an advantageous embodiment making it possible to confer good tear strength properties and which may be combined with the other embodiments, the reinforcing filler predominantly comprises carbon black, i.e. comprises at least 51% by weight of carbon black relative to the total weight of the reinforcing filler. Optionally in this advantageous embodiment, the reinforcing filler may also comprise silica or another reinforcing inorganic filler. Preferentially in this advantageous embodiment, carbon black represents more than 60% by weight, preferentially more than 80% by weight, more preferentially more than 90% by weight, preferentially represents 100% by weight, of the total weight of the reinforcing filler.

Preferentially, the content of reinforcing filler in the elastomer composition is within a range from 5 to 70 phr, carbon black representing more than 51% by weight, more than 60% by weight, preferentially more than 80% by weight, more preferentially more than 90% by weight, preferentially represents 100% by weight, of the total weight of the reinforcing filler.

More preferentially, the content of reinforcing filler in the elastomer composition is within a range from 5 to 60 phr, carbon black representing more than 51% by weight, more than 60% by weight, preferentially more than 80% by weight, more preferentially more than 90% by weight, preferentially represents 100% by weight, of the total weight of the reinforcing filler.

More preferentially still, the content of reinforcing filler in the elastomer composition is within a range from 5 to 55 phr, carbon black representing more than 51% by weight, more than 60% by weight, preferentially more than 80% by weight, more preferentially more than 90% by weight, preferentially represents 100% by weight, of the total weight of the reinforcing filler.

More preferentially still, the content of reinforcing filler in the elastomer composition is within a range between 5 and 55 phr, carbon black representing more than 51% by weight, more than 60% by weight, preferentially more than 80% by weight, more preferentially more than 90% by weight, preferentially represents 100% by weight, of the total weight of the reinforcing filler.

More preferentially still, the content of reinforcing filler in the elastomer composition is within a range between 10 and 50 phr, carbon black representing more than 51% by weight, more than 60% by weight, preferentially more than 80% by weight, more preferentially more than 90% by weight, preferentially represents 100% by weight, of the total weight of the reinforcing filler.

More preferentially still, the content of reinforcing filler in the elastomer composition is within a range from 20 to 45 phr, carbon black representing more than 51% by weight, more than 60% by weight, preferentially more than 80% by weight, more preferentially more than 90% by weight, preferentially represents 100% by weight, of the total weight of the reinforcing filler.

### Rubber Crumb

The elastomer composition of the sidewall useful in the context of the present invention also includes rubber crumb.

The crumbs that may be used in the context of the present invention are presented in the form of granules, optionally made into a sheet of rubber. Generally, these crumbs result from grinding or from micronization of vulcanized elastomer compositions that have already been used for a first application, for example in tyres, shoe soles, seals, etc. They are a product of the recycling of these materials.

All rubber crumbs produced from the recycling of elastomer compositions, particularly those from worn tyres, are suitable.

As is known, rubber crumb may be obtained by reducing worn tyres or other rubbers to give granules from which the reinforcing materials, such as steel or textile fibres, and also any other contaminant, such as dust, glass or stones, have been removed.

For example, rubber crumbs were prepared by cryogenic grinding of worn tyres according to the process described in document U.S. Pat. No. 7,445,170, comprising the successive and independent steps of granulation, separation of the metal and textile reinforcements, cooling and micronization in order to obtain a coarse distribution of micronic particles of vulcanized mixture (also referred to as microparticles). This micronization may be carried out using a conical impact mill as described in document U.S. Pat. No. 7,861,958. The cryogenized input enters the mill (for example, the CUM150 mill from Netzsch or the CW250 mill from Alpine may be used), and is then transferred by gravity to a rotor rotating at high speed. The cryogenized input is thus sprayed onto the walls of the rotor chamber multiple times, leading to its micronization. The particles may then pass through a series of two vibrating screens of the same size in order to separate the last elements not made of vulcanized mixture. A coarse distribution of micronic particles of vulcanized mixture is obtained. The term “microparticles” is understood to mean particles which exhibit a size, namely their diameter in the case of spherical particles or their greatest dimension in the case of anisometric particles, of a few tens of or a few hundred microns. The size of the microparticles may be determined by techniques known to those skilled in the art, such as microscopy, for example.

In embodiments, the rubber crumb is simple ground/micronized rubber, without further processing. It is also known practice to subject rubber crumb to a treatment in order to modify same. This treatment can consist of a chemical functionalization or devulcanization modification. It can also be a thermomechanical, thermochemical, biological, and the like, treatment.

According to an advantageous embodiment which gives the sidewall good tear strength properties and which can be combined with the other embodiments, the rubber crumb is a crumb which has not undergone any modification by a treatment selected from the group consisting of heat, mechanical, biological and chemical treatments and combinations thereof.

According to an advantageous embodiment which gives the sidewall good tear strength properties and which can be combined with the other embodiments, the rubber crumb may have a microparticle size distribution such that it comprises less than 1% by mass of microparticles not retained through a 600 μm screen and less than 10% by mass of microparticles not retained through a 105 μm screen relative to the total mass of microparticles in the rubber crumb, more preferably a microparticle size distribution such that it comprises less than 1% by mass of microparticles not retained through a 600 μm screen and less than 10% by mass of microparticles not retained through a 149 μm screen; more preferably still a microparticle size distribution such that it comprises less than 1% by mass of microparticles not retained through a 600 μm screen and less than 10% by mass of microparticles not retained through a 177 μm screen; a microparticle size distribution such that it comprises less than 1% by mass of microparticles not retained through a 400 μm screen, and less than 10% by mass of microparticles not retained through a 177 μm screen relative to the total mass of microparticles in the rubber crumb. The distribution of rubber crumb microparticles being determined according to the standard ASTM D5644-01:2013.

According to an advantageous embodiment which gives the sidewall good tear strength properties and which can be combined with the other embodiments, the rubber crumb may have a microparticle size distribution such that it comprises less than 1% by mass of microparticles not retained through a 250 μm screen and less than 10% by mass of microparticles not retained through a 177 μm screen relative to the total mass of microparticles in the rubber crumb.

To obtain such a rubber crumb with such a distribution, an additional sieving step according to a size criterion was carried out. Sieving may be carried out by different technologies (vibration, centrifugation, suction) known to those skilled in the art. Preferably, this sieving step is carried out using a series of screens stacked in order of size (screens with calibrated mesh sizes such as the commercial products from Gericke, for example).

Thus, the larger particles are retained on the screen while the smaller ones pass to the lower stage on the next screen. Those skilled in the art will understand that the distributions considered below may be composed of all the particles that pass through a given screen or of all the particles retained between 2 stages.

Rubber crumb is usually made from ingredients obtained from an elastomer composition used in tyres. In other words, rubber crumb is usually made up of a composition based on at least one elastomer and at least one filler, notably a reinforcing filler. It may also include all the ingredients usually used in elastomer compositions, particularly those intended for the manufacture of tyres, such as plasticizers, anti-oxidants, vulcanization additives, etc. These ingredients have been described above and for the sake of brevity are not repeated here.

Thus, the rubber crumbs comprise at least one diene elastomer as described above and at least one carbon black as described above. This diene elastomer preferentially represents at least 30% by mass, more preferentially at least 35% by mass, even more preferentially at least 40% by mass relative to the weight of the rubber crumb, said percentage being determined according to the standard ASTM E1131-03. The carbon black is preferentially present in the rubber crumb at a content ranging from 20 to 40% by mass, more preferentially from 25 to 35% by mass relative to the weight of the rubber crumb; percentage determined according to the method described above.

The carbon black mass fraction is measured by thermogravimetric analysis (TGA) according to the standard NF T-46-07, on an instrument from the company Mettler Toledo, model “TGA/DSC1”. Approximately 20 g of sample are introduced into the thermal analyser, then subjected to a thermal program from 25 to 600° C. under an inert atmosphere (pyrolysable phase), then from 400 to 750° C. under an oxidizing atmosphere (oxidizable phase). The mass of the sample is measured continuously throughout the thermal program. The organic matter content corresponds to the loss of mass measured during the pyrolysable phase relative to the initial mass of sample. The black content corresponds to the loss of mass measured during the oxidizable phase relative to the initial mass of sample.

Those skilled in the art will know how to adapt the content of rubber crumb to the needs of the invention. The rubber crumbs that may be used in the context of the present invention are commercially available from suppliers such as Lehigh Technology, for example.

Preferably, the content of rubber crumb is within a range from 2 to 35 phr, more preferentially between 5 and 33 phr, more preferentially from 6 to 32 phr, more preferentially from 7 to 31 phr, more preferentially still from 8 to 30 phr.

According to an advantageous embodiment which gives the sidewall good tear strength properties, the weight ratio between the content of rubber crumb expressed in phr and the content of reinforcing filler expressed in phr is within a range from 0.25 to 1.50, preferably from 0.25 to 1.30, more preferentially from 0.25 to 1.10 and even more preferentially from 0.28 to 1.03.

### Crosslinking System

In embodiments, the elastomer composition comprises at least one crosslinking system.

The crosslinking system may be any type of system known to those skilled in the art in the field of elastomer compositions for tyres. It may notably be based on sulphur and/or on peroxide and/or on bismaleimides.

Preferentially, the crosslinking system is based on sulphur; it is then referred to as a vulcanization system. The sulphur may be provided in any form, notably in the form of molecular sulphur or a sulphur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retarders. Use may be made, as accelerator, of any compound that is capable of acting as an accelerator of the vulcanization of diene elastomers in the presence of sulphur, notably accelerators of the thiazole type, and also derivatives thereof, or accelerators of sulphenamide, thiuram, dithiocarbamate, dithiophosphate, thiourea and xanthate types.

Sulphur may be used in a preferential content within a range from 0.5 to 12 phr, in particular from 0.7 to 7 phr. The vulcanization accelerator may be used in a preferential content within a range from 0.5 to 10 phr, more preferentially from 0.5 to 5.0 phr.

### Other Additives

The elastomer compositions may also optionally comprise all or some of the usual additives and processing aids known to those skilled in the art and generally used in elastomer compositions, notably intended for the manufacture of tyres, in particular sidewalls, such as, for example, plasticizers (such as plasticizing oils and/or plasticizing resins), non-reinforcing fillers, pigments, protective agents, such as anti-ozone waxes, chemical anti-ozonants, anti-oxidants, anti-fatigue agents or reinforcing resins (such as described, for example, in application WO 02/10269).

### Plasticizing Agent

In embodiments making it possible to soften the sidewall and thus make it less susceptible to tearing, the elastomer composition optionally comprises at least one plasticizing agent (i.e., one or more plasticizing agents). In addition to improving tear strength, the plasticizing agent helps to reduce the hysteresis of the sidewall of the tyre and therefore the rolling resistance of the tyre.

In preferred and optional embodiments, the plasticizing agent is selected from the group consisting of plasticizing oils, plasticizing resins having a high Tg, and mixtures of these plasticizing agents.

According to an advantageous embodiment which gives the sidewall good tear strength properties and which can be combined with the other embodiments, the elastomer composition comprising a plasticizing agent, the content of plasticizing agent is within a range from 2 to 28 phr, more preferentially from 7 to 24 phr, more preferentially still from 10 to 20 phr.

Any extender oil, whether aromatic or non-aromatic in nature, known for its plasticizing properties towards the elastomer matrix, may be used. At room temperature (23° C.), these oils, which are more or less viscous, are liquids (that is to say, as a reminder, substances which have the ability to take on the shape of their container), as opposed, notably, to hydrocarbon resins having a high Tg, which are by nature solid at room temperature and atmospheric pressure.

The plasticizing oil generally has a glass transition temperature, Tg, below −20° C., preferably below −40° C. The Tg of the plasticizing oil is measured according to the standard ASTM D3418 (2008).

In some embodiments, plasticizing oils selected from the group consisting of naphthenic oils (of high or low viscosity, in particular hydrogenated or non-hydrogenated), paraffinic oils, DAE (Distillate Aromatic Extract) oils, polyolefin oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulphonate plasticizers, and mixtures of these plasticizing oils, are particularly suitable as plasticizing agent for the elastomer composition.

According to an advantageous embodiment which gives the sidewall good tear strength properties and which can be combined with the other embodiments, the plasticizing agent is an oil selected from the group consisting of MES oils, TDAE oils, RAE oils, TRAE oils, SRAE oils, mineral oils, vegetable oils, and mixtures of these plasticizing oils.

By definition, a hydrocarbon resin having a high Tg is a solid at room temperature and ambient pressure (23° C., 1 atm), whereas a plasticizing oil is liquid at room temperature and a hydrocarbon resin having a low Tg is viscous at room temperature.

Hydrocarbon resins, also known as hydrocarbon plasticizing resins, are polymers that are well known to those skilled in the art, essentially based on carbon and hydrogen but which may include other types of atoms, for example oxygen, and can be used in particular as plasticizers or tackifiers in polymer matrices. They are by nature at least partially miscible (i.e. compatible) at the contents used with the polymer compositions for which they are intended, so as to act as true diluents. They have been described, for example, in the work entitled “Hydrocarbon Resins” by R. Mildenberg, M. Zander and G. Collin (New York, V C H, 1997, ISBN 3-527-28617-9), Chapter 5 of which is devoted to their applications, in particular in the tyre rubber field (5.5. “Rubber Tires and Mechanical Goods”). In a known manner, these hydrocarbon resins may also be described as thermoplastic resins in the sense that they soften when heated and can thus be moulded.

The softening point of the hydrocarbon resins is measured according to standard ISO 4625 (“Ring and Ball” method). The Tg of the hydrocarbon resin is measured according to the standard ASTM D3418 (2008). The macrostructure (Mw, Mn and PDI) of the hydrocarbon resin is determined by size exclusion chromatography (SEC): solvent tetrahydrofuran; temperature 35° C.; concentration 1 g/l; flow rate 1 ml/min; solution filtered through a filter with a porosity of 0.45 □m before injection; Moore calibration with polystyrene standards; set of 3 Waters columns in series (Styragel HR4E, HR1 and HR0.5); detection by differential refractometer (Waters 2410) and its associated operating software (Waters Empower).

The hydrocarbon resins may be aliphatic, aromatic or of the aliphatic/aromatic type, i.e. based on aliphatic and/or aromatic monomers. They may be natural or synthetic and may or may not be petroleum-based (if such is the case, they are also known as petroleum resins). Examples of aromatic monomers that are suitable include styrene, α-methylstyrene, indene, ortho-, meta-, para-methylstyrene, vinyltoluene, para-tert-butylstyrene, methoxystyrenes, chlorostyrenes, vinylmesitylene, divinylbenzene, vinylnaphthalene and any vinylaromatic monomer derived from a C9 cut (or more generally from a C8 to C10 cut). Preferably, the vinylaromatic monomer is styrene or a vinylaromatic monomer derived from a C9 cut (or more generally from a C8 to C10 cut). Preferably, the vinylaromatic monomer is the minor monomer, expressed as a mole fraction, in the copolymer under consideration.

In some embodiments, the hydrocarbon plasticizing resins selected from the group consisting of cyclopentadiene (abbreviated to CPD) or dicyclopentadiene (abbreviated to DCPD) homopolymer or copolymer resins, terpene homopolymer or copolymer resins, terpene phenol homopolymer or copolymer resins, C5 cut homopolymer or copolymer resins, C9 cut homopolymer or copolymer resins, α-methylstyrene homopolymer and copolymer resins and mixtures of these resins are particularly suitable as plasticizing agent for the elastomer composition. The term “terpene” groups together here, in a known manner, α-pinene, β-pinene and limonene monomers; use is preferably made of a limonene monomer, this compound existing, in a known manner, in the form of three possible isomers: L-limonene (laevorotatory enantiomer), D-limonene (dextrorotatory enantiomer) or else dipentene, the racemate of the dextrorotatory and laevorotatory enantiomers. Mention will in particular be made, among the above hydrocarbon plasticizing resins, of α-pinene, β-pinene, dipentene or polylimonene homopolymer or copolymer resins.

Very preferentially, the hydrocarbon resin is predominantly composed of units derived from C5 monomers. The term “C5 monomers” is understood to mean, conventionally for those skilled in the art, the monomers resulting from C4 to C6 oil cuts. Suitable for example are 1,3 pentadienes, which may be cis and trans, pentenes, cyclopentadiene, cyclopentene, pyperylene, isoprene etc. This “C5” resin, predominantly composed of units derived from C5 monomers, may comprise, in addition to these units, and in a minority capacity, aliphatic or aromatic units or units of the aliphatic/aromatic type, that is to say based on aliphatic and/or aromatic monomers, other than C5. Preferably, the hydrocarbon resin that may be used is predominantly composed of units derived from C5 monomers, has an aromatic proton content of less than 20%, preferably less than 15%, more preferentially an aromatic proton content within a range from 7 to 15%, preferably 9 to 13%. Preferably again, this hydrocarbon resin has an ethylenic proton content of less than 15%, preferably less than 7%, more preferentially less than 5%. Preferentially, the C5 hydrocarbon resin has a glass transition temperature (Tg) within a range from 30° C. to 80° C., preferably from 40 to 60° C. The C5 hydrocarbon resin has an average molecular weight Mn within a range from 500 g/mol to 3000 g/mol and preferably from 700 to 2000 g/mol. Preferably, the hydrocarbon resin has a polydispersity index (PI) within a range from 1 to 4, preferably from 1.5 to 3.5, more preferentially from 1.7 to 3. Numerous hydrocarbon resins are available commercially. These resins may have characteristics, notably in terms of chemical composition, of Tg, of Mn, of aromatic or ethylenic proton content or of PI, which differ depending on the supplier. The macrostructure (Mw, Mn, PI and Mz) of the hydrocarbon resin is determined by size exclusion chromatography (SEC) on the basis of standards ISO 16014 (Determination of average molecular weight and molecular weight distribution of polymers using size exclusion chromatography), ASTM D5296 (Molecular weight averages and molecular weight distribution of polystyrene by high performance size exclusion chromatography) and DIN 55672 (size exclusion chromatography). The aromatic proton content (% AH) and the ethylenic proton content (% EH) are measured by ¹H NMR. This determination is performed with respect to all of the signals detected. Thus, the results obtained are expressed as percentage of the peak area. The C5 resins are commercially available, for example sold by Eastman under the name Piccotac 1105 or Impera R1507, by Exxon under the name Escorez 1102, by Kolon under the name Hikorez A1100 or also by Cray Valley Total under the name Wingtack 98. The C5-C9 resins are commercially available, for example sold by Exxon under the name Oppera 373, by Eastman under the name Piccotac 8090 or by Cray Valley Total under the name Wingtack STS.

When the plasticizing agent is a mixture of a hydrocarbon resin and an oil, the plasticizing agent content is the sum of the hydrocarbon resin content in phr and the oil content in phr, for the calculation of the ratio described above.

According to an advantageous embodiment which gives the sidewall good tear strength properties, the elastomer composition comprising a plasticizing agent, the weight ratio between the content of reinforcing filler expressed in phr and the content of plasticizing agent expressed in phr is less than or equal to 4.50, preferably 4.00 and more preferentially 3.75.

According to an advantageous embodiment which gives the sidewall good tear strength properties, the elastomer composition comprising a plasticizing agent, the weight ratio between the content of reinforcing filler expressed in phr and the content of plasticizing agent expressed in phr is greater than or equal to 1.00, preferably 2.00 and more preferentially 2.42.

### Anti-Ozone Wax

Anti-ozone waxes are known and may be, for example, paraffinic waxes, microcrystalline waxes or mixtures of paraffinic and microcrystalline waxes. They consist of a mixture of linear alkanes and of non-linear alkanes (isoalkanes, cycloalkanes, branched alkanes) resulting from the refining of oil or from the catalytic hydrogenation of carbon monoxide (Fischer-Tropsch process) predominantly comprising chains of at least 20 carbon atoms.

All known anti-ozone waxes may be used, including natural waxes, such as, for example, candelilla wax or carnauba wax. These waxes may, furthermore, be used as blends.

Anti-ozone waxes are commercially available, for example, Varazon 4959, Varazon 6500 and Varazon 6810 from Sasol, Ozoace 0355 from Nippon Seiro, Negozone 9343 from H&R and H3841 from Yanggu Huatai.

According to a preferred embodiment of the elastomer composition which may be used in the context of the present invention and which may be combined with the embodiments of the invention, the wax content is within a range from 1 to 3 phr, more preferentially within a range from 1.2 phr to 2.8 phr.

Process for preparing the elastomer composition which may be used in the context of the present invention

The elastomer composition which may be used in the context of the present invention is manufactured in appropriate mixers using two successive phases of preparation which are well known to those skilled in the art:
a first phase of thermomechanical working or kneading (known as the “non-productive” phase), that can be performed in a single thermomechanical step during which all the necessary constituents, in particular the elastomer matrix, the reinforcing filler, the rubber crumb and the various other optional additives, with the exception of the crosslinking system, are introduced into an appropriate mixer, such as a standard internal mixer (for example of “Banbury” type). The non-productive phase may be performed at high temperature, up to a maximum temperature within a range from 110° C. to 200° C., preferably from 130° C. to 185° C., for a period of time generally between 2 and 10 minutes;
a second phase of mechanical working (known as the “productive” phase), which is carried out in an external mixer, such as an open mill, after cooling the mixture obtained during the first non-productive phase down to a lower temperature, typically of less than 120° C., for example within a range from 40° C. to 100° C. The crosslinking system, preferably the vulcanization system (notably the vulcanization agent, the vulcanization accelerator and optionally the vulcanization retarder, if present) are then incorporated and the combined mixture is then mixed for a few minutes, for example from 5 to 15 min.

The final elastomer composition thus obtained is then calendered, for example in the form of a sheet or a plaque, notably for laboratory characterization, or is extruded in the form of a semi-finished rubber product (or profiled element) that can be used for a tyre sidewall.

The elastomer composition can be either in the raw state (before crosslinking or vulcanization) or in the cured state (after crosslinking or vulcanization), can be a semi-finished product which can be used in a tyre.

The crosslinking, notably vulcanization, of the elastomer composition may be carried out in a manner known to those skilled in the art, for example at a temperature within a range from 130° C. to 200° C., under pressure.

The tyres are intended for passenger vehicles as defined in the 2021 ETRTO Standards Manual. Such a tyre has a cross section in a meridian section plane characterized by a section height H and a nominal section width S as defined by the 2021 ETRTO Standards Manual, such that, optionally, the ratio H/S, expressed as a percentage, is at most equal to 90, preferably at most equal to 50 and more preferably at most equal to 40 and is at least equal to 20, preferably at least equal to 25, and the nominal section width S is at least equal to 155 mm, preferably at least equal to 205 mm and more preferably at least equal to 225 mm and at most equal to 385 mm, preferably at most equal to 335. Furthermore, the diameter at the flange D, defining the diameter of the tyre mounting rim, is at least equal to 12 inches, preferably at least equal to 16 inches and at most equal to 24 inches.

Optionally, the tyre comprises a carcass reinforcement comprising at least one carcass layer anchored in the or each bead and extending radially in the or each sidewall and axially in the crown radially to the inside of the crown reinforcement.

Optionally, the or each carcass layer is delimited axially by two axial ends and comprises carcass reinforcing elements extending axially from one axial end to the other of said carcass layer in a main direction that optionally and preferably forms, with the circumferential direction of the tyre, an angle with an absolute value that is greater than or equal to 60°, preferably from 80° to 90°.

In certain variants, the carcass reinforcement comprises a single carcass layer anchored in the or each bead and extending radially in each sidewall and axially in the crown radially to the inside of the crown reinforcement. A single carcass layer anchored in the or each bead is understood to mean that the carcass reinforcement is, with the exception of the carcass layer, not provided with any layer reinforced with reinforcing elements and anchored in the or each bead. The reinforcing elements of such reinforced layers excluded from the carcass reinforcement of the tyre comprise metal reinforcing elements and textile reinforcing elements. The carcass reinforcement is very preferably formed by the single carcass layer. More preferentially still, the tyre has no sidewall reinforcing layer as defined hereinbelow.

In a first configuration of the carcass reinforcement comprising a single carcass layer, the carcass layer anchored in each bead is wrapped around a circumferential reinforcing element of each bead such that an axially inner portion of the carcass layer anchored in each bead is arranged axially to the inside of an axially outer portion of the carcass layer anchored in each bead.

In a second configuration of the carcass reinforcement comprising a single carcass layer, each bead comprises an axially inner circumferential reinforcing element arranged axially to the inside of the carcass layer and an axially outer circumferential reinforcing element arranged axially to the outside of the carcass layer, for example as described in WO 2021/123522.

In certain variants, the carcass reinforcement comprises first and second carcass layers anchored in the or each bead and extending radially in each sidewall and axially in the crown radially to the inside of the crown reinforcement.

In a first configuration of the carcass reinforcement comprising first and second carcass layers, the first carcass layer is wrapped around a circumferential reinforcing element of each bead such that an axially inner portion of the first carcass layer is arranged axially to the inside of an axially outer portion of the first carcass layer and such that each axial end of the first carcass layer is arranged radially to the outside of each circumferential reinforcing element, and each axial end of the second carcass layer is arranged radially to the inside of each axial end of the first layer.

In a first variant of the first configuration, each axial end of the second carcass layer is arranged axially between the axially inner and outer portions of the first carcass layer. In this variant, the second carcass layer is arranged radially to the outside of the first carcass layer in the crown.

In a second variant of the first configuration, each axial end of the second carcass layer is arranged axially to the inside of each axially inner portion of the first carcass layer. In this variant, the second carcass layer is arranged radially to the inside of the first carcass layer in the crown and axially to the inside of the first carcass layer in each sidewall.

Such arrangements of the first and second carcass layers in the first and second variants make it possible to obtain effective mechanical coupling between the first and second carcass layers making it possible to reduce shearing between the first and second carcass layers. This then reduces the dissipation of energy and the increase in tyre temperature, especially given that shearing is particularly significant at high load.

Furthermore, thanks to the particular arrangement of the first and second carcass layers, a tyre is obtained that surprisingly exhibits optimal energy dissipation and optimal operating temperature in the sidewall, notably at high load and under a pressure lower than or equal to the recommended pressure for a tyre of the same size in its STANDARD LOAD or EXTRA LOAD version. This is all the more surprising given that the particular arrangement of the first and second carcass layers is in one region of the tyre, in this instance in the bead or near the bead, but enables a reduction in the dissipation of energy in another region of the tyre, distant from the bead, in this instance in the sidewall. It has been discovered that the particular arrangement of the carcass reinforcement, namely the fact that each axial end of the second carcass layer is arranged axially between the axially inner and outer portions of the first carcass layer, or axially to the inside of the axially inner portion of the first carcass layer, makes it possible to reduce the difference in tension between the first carcass layer and the second carcass layer. As a matter of fact, the greater the reduction in the difference in tension between the first and second carcass layers, the less shearing is generated between these first and second carcass layers, and the less energy is dissipated.

In a third variant of the first configuration, each axial end of the second carcass layer is arranged axially to the outside of each axially outer portion of the first carcass layer. In this variant, the second carcass layer is arranged radially to the outside of the first carcass layer in the crown and axially to the outside of the first carcass layer in each sidewall.

This third variant is particularly advantageous for tyres that have relatively tall sidewalls. Specifically, for tyres of the HIGH LOAD CAPACITY type having a relatively great sidewall height, because the tension in the end of the first carcass layer becomes high, it is preferable to envisage a carcass reinforcement in which, unlike in the arrangement described in the first and second configurations, each axial end of the second carcass layer is arranged axially to the outside of each axially outer portion of the first carcass layer. With such a carcass reinforcement arrangement, the tension in the end of the first carcass layer will be reduced to a lower level.

In a second configuration of the carcass reinforcement comprising first and second carcass layers, with each bead comprising at least first and second circumferential reinforcing elements, a portion of each first and second carcass layer is arranged axially between two of the at least first and second circumferential reinforcing elements. Such configurations are notably described in WO 2021/123522.

Irrespective of the number of carcass layers in each first configuration, in certain variants, each axial end of the carcass layer or of the first carcass layer is arranged radially to the inside of the equator of the tyre, and more preferentially still, arranged at a radial distance less than or equal to 30 mm from a radially inner end of each circumferential reinforcing element of each bead.

By arranging each axial end of the wrapped carcass layer to the inside of the equator of the tyre, the mass of the carcass reinforcement is significantly reduced. Furthermore, the vast majority of rims that are currently used for tyres for passenger vehicles have J-type flanges with a height which, in all cases, is less than 30 mm. The greatly preferred arrangement of each axial end in a region corresponding radially substantially to the rim flange makes it possible to mechanically protect each axial end. Specifically, if each axial end were arranged radially too high above each circumferential reinforcing element of each bead, namely at a radial distance of strictly greater than 30 mm from the radially inner end of each circumferential reinforcing element, each axial end would then be situated in a flexible region of the tyre that is subjected to excessively high stresses, and these stresses are extremely high in the case of a tyre of the HIGH LOAD CAPACITY type.

Irrespective of the number of carcass layers in each first configuration, in other variants, each axial end of the carcass layer or of the first carcass layer is arranged radially to the outside of the equator of the tyre. Advantageously, in these other embodiments, each axial end of the carcass layer or of the first carcass layer is highly preferentially arranged axially to the inside of an axial end of the or of at least one of the crown layer(s) of the crown reinforcement.

In other variants still, the carcass reinforcement comprises a single carcass layer anchored in each bead and extending radially in each sidewall and axially in the crown radially to the inside of the crown reinforcement, the tyre comprising a sidewall reinforcing layer extending at least radially in each sidewall and having:
a radially inner end arranged radially to the inside of the equator of the tyre, and
a radially outer end arranged radially to the outside of the equator of the tyre.

In these other variants still, the invention notably makes it possible to avoid the use of a second carcass layer extending axially in the crown radially to the inside of the crown reinforcement. Thus, the sidewall reinforcing layers are discontinuous under the crown of the tyre.

A sidewall reinforcing layer is not anchored in a bead of the tyre. Thus, the radially inner end of the sidewall reinforcing layer is arranged radially to the outside of the bead.

In some advantageous embodiments, the crown reinforcement comprises a working reinforcement comprising at least one working layer and a hoop reinforcement comprising at least one hooping layer, the hoop reinforcement being arranged radially to the outside of the working reinforcement.

Optionally, the or each hooping layer is delimited axially by two axial ends. The or each hooping layer comprises one or more hoop reinforcing elements wound circumferentially in a helical manner in such a way as to extend axially in a main direction from one axial end to the other of the hooping layer. Optionally, and preferably, the main direction forms, with the circumferential direction of the tyre, an angle with an absolute value that is less than or equal to 10°, preferably less than or equal to 7° and more preferentially less than or equal to 5°.

Optionally, the or each working layer is delimited axially by two axial ends. The or each working layer comprises working reinforcing elements that extend axially from one axial end to the other, substantially parallel to one another in a main direction which optionally and preferably forms, with the circumferential direction of the tyre, an angle with an absolute value that is strictly greater than 10°, preferably from 15° to 50° and more preferably from 25° to 45°.

As a preference, the or each hoop, working and carcass reinforcing element is a filamentary reinforcing element.

The expression “reinforcing element” means an element providing mechanical reinforcement to the polymer matrix in which this reinforcing element is intended to be embedded.

Preferably, each reinforcing element is filamentary, which means to say that each reinforcing element has a length at least 10 times greater than the largest dimension of its cross section, regardless of the shape of the latter: circular, elliptical, oblong, polygonal, in particular rectangular or square or oval. In the case of a rectangular cross section, the filamentary reinforcing element has the shape of a strip.

In optional but advantageous embodiments, the tyre has a sidewall height H defined by H=SW×AR/100 where SW is the nominal section width and AR is the nominal aspect ratio of the tyre, and a load index LI satisfying 0.72≤H/LI≤0.98, preferably 0.82≤H/LI≤0.98, and even more preferentially 0.82≤H/LI≤0.92, where SW, AR and LI are defined in accordance with the 2021 ETRTO Standards Manual. The nominal section width SW and the nominal aspect ratio AR are those from the size marking marked on the sidewall of the tyre and are, for example, in accordance with the 2021 ETRTO Standards Manual. Such H/LI ratios are characteristic of tyres with a sidewall likely to flex very considerably considering the height of the sidewall relative to the maximum load that can be borne.

The invention will be understood better from reading the following description, which is given solely by way of non-limiting example and with reference to the drawings, in which:

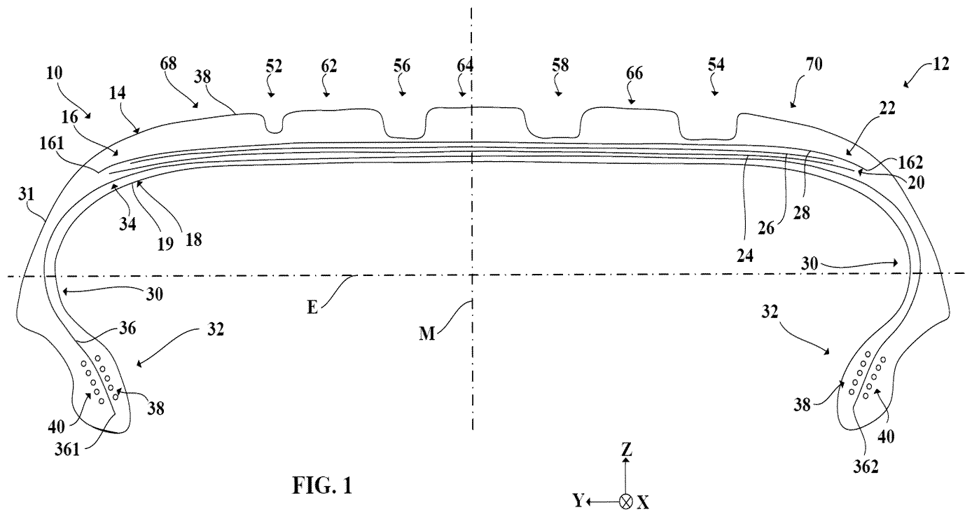

FIG. 1 is a view, in a meridian section plane parallel to the axis of rotation of the tyre, of a tyre according to a first embodiment of the invention,

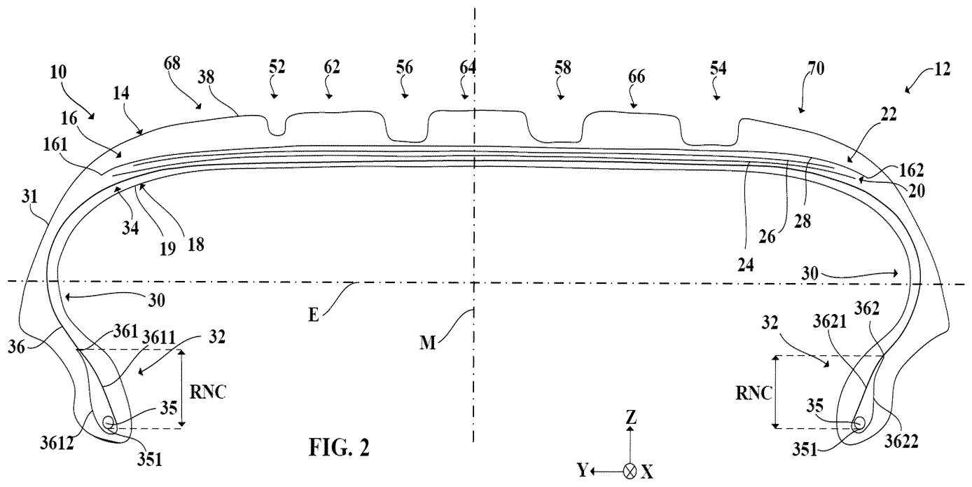

FIGS. 2 to 6 are views similar to that in FIG. 1, of tyres according to second, third, fourth, fifth and sixth embodiments of the invention, respectively.

A frame of reference X, Y, Z corresponding respectively to the usual axial (Y), radial (Z) and circumferential (X) directions of a tyre is shown in the figures relating to the tyre.

FIG. 1 shows a tyre according to the invention, denoted by the general reference number 10. The tyre 10 has a substantially toric shape about an axis of revolution substantially parallel to the axial direction Y. The tyre 10 is intended for a passenger vehicle and is of the size 255/35 R18. The tyre 10 is of the HIGH LOAD CAPACITY type according to the 2021 ETRTO Standards Manual. In the various figures, the tyre 10 is shown as new, i.e. when it has not yet been run. The tyre 10 has a sidewall height H defined by H=SW×AR/100 where SW is the nominal section width, in this case 255, and AR is the nominal aspect ratio of the tyre, in this case 35. The load index LI is in this case equal to 98. Thus, the load index LI satisfies 0.72≤H/LI≤0.98, preferably 0.82≤H/LI≤0.98, and even more preferentially 0.82≤H/LI≤0.92, and in this case H/LI=0.91. SW, AR and LI are defined in accordance with the 2021 ETRTO Standards Manual.

The tyre 10 comprises a crown 12 comprising a tread 14 intended to come into contact with the ground when it is running and a crown reinforcement 16 extending in the crown 12 in the circumferential direction X. The tyre 10 also comprises an airtight inner liner 18 which is impervious to an inflation gas and is intended to delimit an internal cavity with a mounting support of the tyre 10, once the tyre 10 has been mounted on the mounting support, for example a rim, this cavity being intended to be pressurized with the inflation gas. The airtight inner liner 18 bears an internal surface 19 of the tyre 10. The tyre 10 also has an external surface 31.

The crown reinforcement 16 comprises a working reinforcement 20 and a hoop reinforcement 22, each of these reinforcements 20, 22 comprising at least one crown layer. The working reinforcement 20 comprises at least one working layer and, in this instance, comprises two working layers comprising a radially inner working layer 24 arranged radially to the inside of a radially outer working layer 26.

The hoop reinforcement 22 comprises at least one hooping layer and, in this instance, one hooping layer 28.

The crown reinforcement 16 is arranged radially to the inside of the tread 14. In this instance, the hoop reinforcement 22, in this case the hooping layer 28, is arranged radially to the outside of the working reinforcement 20 and is therefore interposed radially between the working reinforcement 20 and the tread 14.

The tyre 10 comprises two sidewalls 30 that continue the crown 12 radially towards the inside. The tyre 10 also has two beads 32 radially inside the sidewalls 30. Each sidewall 30 connects each bead 32 to the crown 12. Each sidewall 30 bears part of the external surface 31 of said sidewall 30. Each sidewall 30 comprises an elastomer composition as described above and illustrated by examples below.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown 12, radially to the inside of the crown reinforcement 16.

For the purpose of anchoring the carcass layer 36, the tyre 10 comprises an axially inner circumferential reinforcing element 38 arranged axially to the inside of the carcass layer 36 and an axially outer circumferential reinforcing element 40 arranged axially to the outside of the carcass layer 36. Here, each reinforcing element 38, 40 comprises a continuous filamentary reinforcing element wound over several circumferential turns, for example as described in WO 2021/123522.

The crown reinforcement 16 comprises two axial ends 161, 162 which in this case coincide with the ends of the axially widest layer of the crown reinforcement 16.

Each working layer 24, 26, hooping layer 28 and carcass layer 36 comprises a polymer matrix, in this case an elastomer matrix, in which one or more reinforcing elements of the corresponding layer, in this case filamentary reinforcing elements, are embedded. The matrix is referred to as a polymer matrix because it is based on a polymer composition, this polymer composition possibly comprising one or more polymers, for example selected from thermoplastic polymers, thermosetting polymers, elastomers, thermoplastic elastomers, and also fillers and other components usually used in the field of compositions for tyres, in particular compositions for embedding reinforcing elements.

The hoop reinforcement 22, in this case the hooping layer 28, is axially delimited by two axial ends, in this case the axial ends 161, 162. The hoop reinforcement 22 comprises one or more filamentary hoop reinforcing elements wound circumferentially in a helix so as to extend axially from one axial end of the hooping layer 28 to the other in a main direction DO. The main direction DO forms, with the circumferential direction X of the tyre 10, an angle AF with an absolute value that is less than or equal to 10°, preferably less than or equal to 7°, and more preferably less than or equal to 5°. In this case, AF=−5°.

The radially inner working layer 24 is delimited axially by two axial ends. The radially inner working layer 24 comprises filamentary working reinforcing elements extending axially from one axial end to the other substantially parallel to one another in a main direction D1. Similarly, the radially outer working layer 26 is delimited axially by two axial ends. The radially outer working layer 26 comprises filamentary working reinforcing elements extending axially from one axial end to the other substantially parallel to one another in a main direction D2. Each main direction D1, D2 forms, with the circumferential direction X of the tyre 10, respective angles AT1 and AT2 of opposite orientations. Each main direction D1, D2 forms, with the circumferential direction X of the tyre 10, an angle AT1, AT2 respectively, with an absolute value that is strictly greater than 10°, preferably from 15° to 50° and more preferably from 25° to 45°. In this case, AT1=−33° and AT2=+33°.

The carcass layer 36 is delimited axially by two axial ends 361, 362. The carcass layer 36 comprises filamentary carcass reinforcing elements extending axially from one axial end 361, 362 to the other of the carcass layer 36 in a main direction D3 which, with the circumferential direction X of the tyre 10, forms an angle AC, with an absolute value that is greater than or equal to 60°, preferably from 80° to 90°, and in this case AC=+90°.

Each filamentary hoop reinforcing element, working reinforcing element and carcass reinforcing element is, for example, identical to those described in application WO 2021/123522.

The tread 14 comprises a tread surface 38 via which the tread 14 comes into contact with the ground. The tread 14 comprises several circumferential cuts, here several circumferential grooves, comprising first, second, third and fourth circumferential cuts respectively designated by the references 52, 54, 56, 58.

The tread 14 also comprises several central ribs and here first, second and third central ribs respectively designated by the references 62, 64, 66. Each central rib 62, 64, 66 is arranged axially between two of the adjacent circumferential cuts 52 to 58 and is delimited axially by two adjacent circumferential cuts 52 to 58. The tread 14 also comprises first and second lateral ribs 68, 70.

Even though this is not visible in FIG. 1, each central rib 62, 64, 66 and each lateral rib 68, 70 comprises transverse cuts made in each central rib 62, 64, 66 and each lateral rib 68, 70.

Tyres according to second, third, fourth, fifth and sixth embodiments of the invention will now be described with reference to FIGS. 2 to 6 respectively, in which figures the elements analogous to those depicted in the preceding figures are designated by the same references.

Unlike the tyre according to the first embodiment, the tyre 10 according to the second embodiment of FIG. 2 is such that the carcass layer 36 anchored in each bead 32 is wrapped around a circumferential reinforcing element 35 of each bead 32, in this case a bead wire, such that an axially inner portion 3611, 3621 of the carcass layer 36 anchored in each bead 32 is arranged axially to the inside of an axially outer portion 3612, 3622 of the carcass layer 36 anchored in each bead 32 and such that each axial end 361, 362 axially delimiting the carcass layer 36 anchored in each bead 32 is arranged radially to the outside of each circumferential reinforcing element 35. Each axial end 361, 362 of the carcass layer 36 anchored in each bead 32 is arranged radially to the inside of the equator E of the tyre. More precisely, each axial end 361, 362 of the carcass layer 36 anchored in each bead 32 is arranged at a radial distance RNC less than or equal to 30 mm from a radially inner end 351 of each circumferential reinforcing element 33 of each bead 32. In this case, RNC=23 mm.

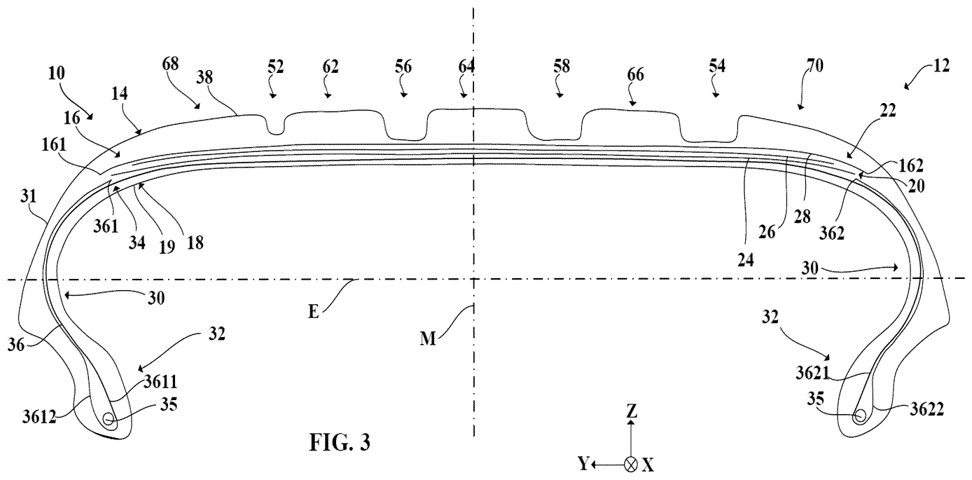

Unlike the tyre according to the second embodiment, the tyre 10 according to the third embodiment of FIG. 3 is such that each axial end 361, 362 of the carcass layer 36 is arranged radially to the outside of the equator E. In this case, each axial end 361, 362 of the carcass layer 36 is highly preferentially arranged axially to the inside of each axial end 161, 162 of the hooping layer 28.

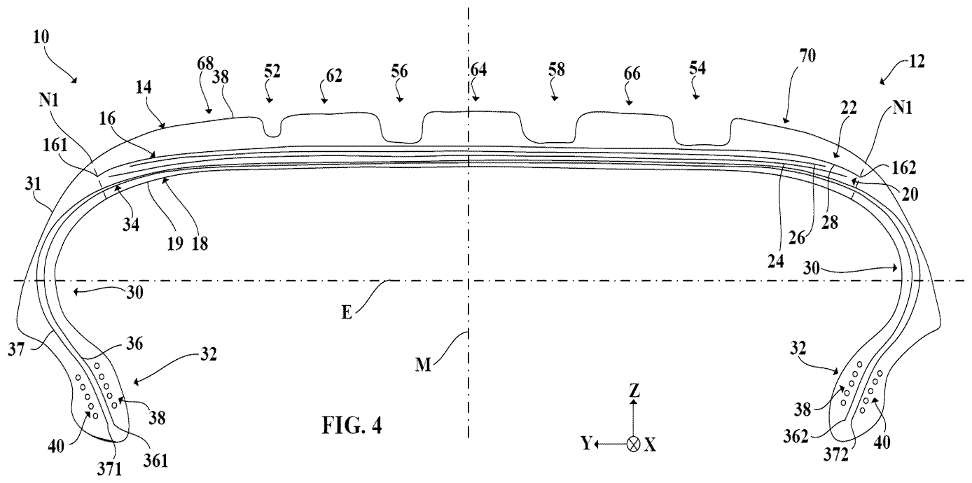

Unlike the tyres according to the preceding embodiments, the carcass reinforcement 34 of the tyre 10 according to the fourth embodiment of FIG. 4 comprises first and second carcass layers 36, 37 anchored in each bead 32 and extending radially in each sidewall 30 and axially in the crown 12 radially to the inside of the crown reinforcement 16. The second carcass layer 37 is arranged axially to the outside of the first carcass layer 36 in each sidewall and radially to the outside of the first carcass layer 37 in the crown 12.

The second carcass layer 37 is delimited axially by two axial ends 371, 372. The second carcass layer 37 comprises filamentary carcass reinforcing elements extending axially from one axial end 371, 372 of the second carcass layer 37 to the other along a main direction D4 which, with the circumferential direction X of the tyre 10, forms an angle AC, with an absolute value that is greater than or equal to 60°, preferably from 80° to 90° and in this case AC=+90°.

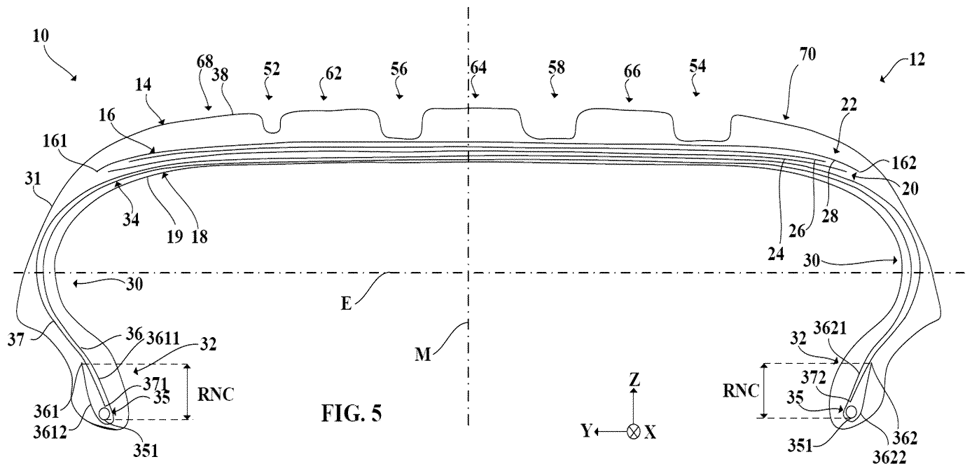

Unlike the tyre according to the fourth embodiment, the tyre 10 according to the fifth embodiment of FIG. 5 is such that the first carcass layer 36 is arranged as in the second embodiment illustrated in FIG. 2. Furthermore, each axial end 371, 372 of the second carcass layer 37 is arranged axially between the axially inner portions 3611, 3621 and axially outer portions 3612, 3622 of the first carcass layer 36. The second carcass layer 37 is arranged radially to the outside of the first carcass layer 36 in the crown 12.

Other alternative arrangements of the second carcass layer 37 are possible, as described earlier in the generic description of the present application.

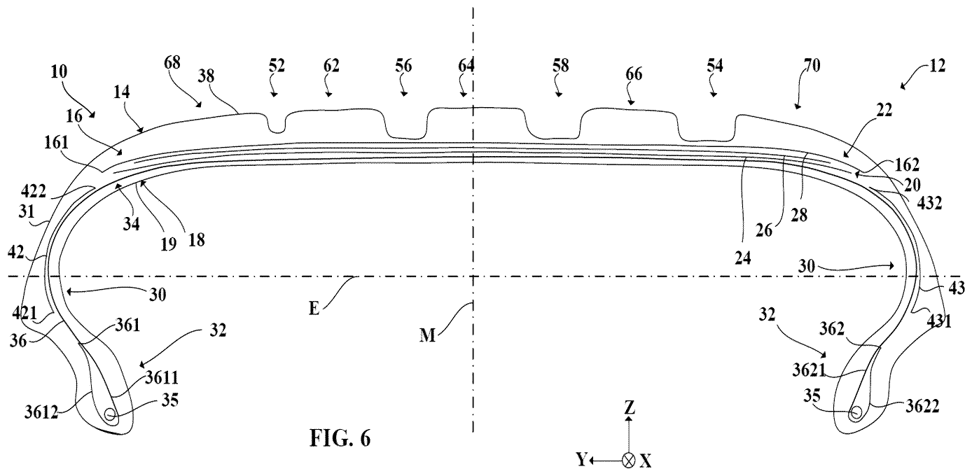

Unlike the first and second embodiments, the tyre 10 according to the sixth embodiment of FIG. 6 comprises two sidewall reinforcing layers 42, 43 extending at least radially in each sidewall 30 and having a radially inner end 421, 431 arranged radially to the inside of the equator E, and a radially outer end 422, 432 arranged radially to the outside of the equator E. The tyre 10 therefore comprises two sidewall reinforcing layers 42, 43 which are discontinuous underneath the crown 12.

### Comparative Tests

In order to confirm the properties of the elastomer composition that may be used in the context of the present invention, eleven elastomer compositions (a reference elastomer composition T1 and elastomer compositions C1 to C10) were used. Each of the formulations of the elastomer compositions is presented in Table 1 with the amount of the various ingredients expressed in phr.

Each elastomer composition was produced as follows: the reinforcing filler, the elastomer matrix, the anti-ozone wax, the rubber crumb when present, the plasticizing agent and the various other ingredients, with the exception of the vulcanization system, were successively introduced into an internal mixer having an initial tank temperature of 60° C.; the internal mixer of “Bandury” type was filled to approximately 70% by volume. The thermomechanical working (non-productive phase) was subsequently carried out in a single step lasting from 3 to 4 minutes, until a maximum “dropping” temperature of 165° C. was reached. The mixture thus obtained was recovered and cooled, and then the vulcanization agent (sulphur) and the vulcanization accelerator (N-cyclohexyl-2-benzothiazolesulphenamide) of the crosslinking system were incorporated in an external mixer (homofinisher) at a temperature of 30° C., everything being mixed (productive phase) for a time of more than 5 minutes and less than 12 minutes.

The elastomer compositions thus obtained were then calendered in the form of sheets for the measurement of their tear strength properties.

### Tear Test

The tear strength is measured in the following way. The force to be exerted in order to obtain breaking (FRD, in MPa (in N/mm)) is determined at 100° C. and the strain at break (DRD, in %) is measured at 100° C. Use is made, in order to do this, of a test specimen of dimensions 10×145×2.5 mm, notched at the centre of its length by 3 notches over a depth of 3 mm, in order to cause the test specimen to break. Thus, the energy for bringing about breaking (breaking energy) of the test specimen, which is the product of the FRD and DRD, can be determined. The force to be exerted in order to obtain breaking and the strain at break are measured on a test specimen stretched to 375 mm/min in order to cause the test specimen to break.

The results (tear performance) are expressed on a base of 100; that is, the value 100 is assigned to the reference tear energy (T1) and the values of the elastomer compositions are presented in Table 1. The higher the value, the less likely the material is to tear, in other words the higher the tear performance.

TABLE 1

| Composition | T1 | C1 | C2 | C3 | C4 | C5 | C6 | C7 | C8 | C9 | C10 |
|---|---|---|---|---|---|---|---|---|---|---|---|
| Elastomer (1) | 53 | 53 | 53 | 53 | 53 | 53 | 53 | 53 | 53 | 53 | 53 |
| Elastomer (2) | 47 | 47 | 47 | 47 | 47 | 47 | 47 | 47 | 47 | 47 | 47 |
| Reinforcing | 57 | 36 | 36 | 13 | 29 | 29 | 29 | 10 | 45 | 17 | 29 |
| filler (3) - A | | | | | | | | | | | |
| Rubber crumb | (—) | 21 | 10 | 33 | 17 | 5 | 30 | 17 | 17 | 10 | 17 |
| (4) - B | | | | | | | | | | | |
| Anti-ozone wax | 1.4 | 1.4 | 1.4 | 1.4 | 1.4 | 1.4 | 1.4 | 1.4 | 1.4 | 1.4 | 1.0 |
| (5) | | | | | | | | | | | |
| Plasticizing | 12 | 12 | 12 | 12 | 12 | 12 | 12 | 12 | 12 | 12 | 12 |
| agent (6) - C | | | | | | | | | | | |
| Anti-oxidant (7) | 5.8 | 5.8 | 5.8 | 5.8 | 5.8 | 5.8 | 5.8 | 5.8 | 5.8 | 5.8 | 5.8 |
| Stearic acid (8) | 1.0 | 1.0 | 1.0 | 1.0 | 1.0 | 1.0 | 1.0 | 1.0 | 1.0 | 1.0 | 1.0 |
| Zinc oxide (9) | 1.2 | 1.2 | 1.2 | 1.2 | 1.2 | 1.2 | 1.2 | 1.2 | 1.2 | 1.2 | 1.2 |
| Vulcanization | 1.3 | 1.3 | 1.3 | 1.3 | 1.3 | 1.3 | 1.3 | 1.3 | 1.3 | 1.3 | 1.3 |
| accelerator (10) | | | | | | | | | | | |
| Sulphur | 1.6 | 1.6 | 1.6 | 1.6 | 1.6 | 1.6 | 1.6 | 1.6 | 1.6 | 1.6 | 1.6 |
| Weight ratio | 4.75 | 3.00 | 3.00 | 1.08 | 2.42 | 2.42 | 2.42 | 0.83 | 3.75 | 1.42 | 2.42 |
| A/C | | | | | | | | | | | |
| Sum A + B | 57 | 57 | 46 | 46 | 46 | 34 | 59 | 27 | 62 | 27 | 46 |
| Weight ratio | 0 | 0.58 | 0.28 | 2.54 | 0.59 | 0.17 | 1.03 | 1.70 | 0.38 | 0.59 | 0.59 |
| B/A | | | | | | | | | | | |
| Tear | 100 | 186 | 125 | 61 | 109 | 64 | 170 | 46 | 196 | 56 | 110 |
| performance | | | | | | | | | | | |

(1) Isoprene elastomer: natural rubber;
(2) Butadiene elastomer: cis-1,4-polybutadiene synthesized with a neodymium catalyst having a cis-1,4 bond content of at least 98 mol %;
(3) Carbon black grade ASTM N550 according to the standard ASTM D1765-14 having an STSA measured according to the standard ASTM D6556-10 equal to 39 m2/g, a COAN index measured according to the standard ASTM D3493-16 equal to 85 ml/100 g;
(4) Rubber crumb obtained by recycling (tyre micronization), rubber crumb sold by Lehigh Technology in which the percentage of crumb microparticles measured according to the standard ASTM D5644-01: 2013 retained by a 250 μm screen is less than 1% by weight and the percentage of crumb particles retained by a 177 μm screen is less than 10% by weight relative to the total weight of the rubber crumb particles, unmodified rubber crumb;
(5) Anti-ozone wax sold by Sasol under the commercial reference “Vazazon 4959”;
(6) TDAE oil sold by H&R under the commercial reference “VivaTec 500”;
(7) Mixture of two anti-oxidants: ((N-(1,3-dimethylbutyl)-N-phenyl-para-phenylenediamine sold by Flexsys under the reference “Santoflex 6-PPD” and 2,2,4-trimethyl-1,2-dihydroquinolone sold by Lanxess;
(8) Stearic acid sold by Uniquema under the reference “Pristerene 4931”;
(9) Zinc oxide: commercial quality, sold by Umicore;
(10) N-dicyclohexyl-2-benzothiazolesulphenamide sold by Flexsys under the reference “Santocure CBS”.

In Table 1 above, the weight ratio A/C is the ratio between the content of reinforcing filler expressed in phr and the content of plasticizing agent expressed in phr, the sum A+B is the sum of the content of reinforcing filler expressed in phr and the content of rubber crumb expressed in phr, and the weight ratio B/A is the ratio between the content of rubber crumb expressed in phr and the content of reinforcing filler expressed in phr.

The results in Table 1 show that the elastomer compositions according to the invention have improved tear performance compared to the control elastomer composition T1 and compared to the elastomer compositions not in accordance with the invention. On a tyre of HIGH LOAD CAPACITY type with sidewalls likely to flex significantly, this performance helps reduce the risk of tearing.

The invention is not limited to the embodiments described above.

1.-11. (canceled)

12. A tire for a passenger vehicle comprising:
a crown;
two beads; and
two sidewalls connecting each bead to the crown,
wherein the tire is a high load capacity tire as defined in 2021 ETRTO Standards Manual, wherein at least one of the two sidewalls comprises an elastomer composition based on at least one elastomer matrix, at least one reinforcing filler, and at least one rubber crumb,
wherein a sum of a content of reinforcing filler and a content of rubber crumb is within a range from 46 to 62 phr, and
wherein a weight ratio between the content of rubber crumb expressed in phr and the content of reinforcing filler expressed in phr is within a range from 0.20 to 1.50.

13. The tire according to claim 12, wherein the elastomer composition further comprises a plasticizing agent, and a weight ratio between the content of reinforcing filler expressed in phr and a content of plasticizing agent expressed in phr is less than or equal to 4.50.

14. The tire according to claim 12, wherein the elastomer composition further comprises a plasticizing agent, and a weight ratio between the content of reinforcing filler expressed in phr and a content of plasticizing agent expressed in phr is greater than or equal to 1.00.

15. The tire according to claim 12, wherein the weight ratio between the content of rubber crumb expressed in phr and the content of reinforcing filler expressed in phr is within a range from 0.25 to 1.50.

16. The tire according to claim 12, wherein the content of reinforcing filler is within a range from 5 to 70 phr.

17. The tire according to claim 12, wherein the elastomer composition further comprises a plasticizing agent, and a content of plasticizing agent is within a range from 2 to 28 phr.

18. The tire according to claim 12, wherein the content of rubber crumb is within a range from 2 to 35 phr.

19. The tire according to claim 12, wherein the reinforcing filler predominantly comprises carbon black.

20. The tire according to claim 12, wherein the elastomer matrix comprises at least one isoprene elastomer and at least one butadiene elastomer.

21. The tire according to claim 12, wherein the elastomer matrix comprises at least one butadiene elastomer in a content within a range from 20 to 80 phr.

22. The tire according to claim 12, wherein the elastomer matrix comprises at least one isoprene elastomer in a content within a range from 20 to 80 phr.
